(19) United States
(12) Patent Application Publication
(10) Pub. No.: US 2011/0231410 A1
(43) Pub. Date: Sep. 22, 2011

(54) MARKETING SURVEY IMPORT SYSTEMS AND METHODS

(75) Inventors: Christopher Hahn, Bellevue, WA (US); Derek Slager, Issaquah, WA (US); Ken Harris, Seattle, WA (US); Stephen Meyles, Seattle, WA (US)

(73) Assignee: Appature, Inc., Seattle, WA (US)

(21) Appl. No.: 13/112,987

(22) Filed: May 20, 2011

Related U.S. Application Data
(63) Continuation-in-part of application No. 12/689,988, filed on Jan. 19, 2010.
(60) Provisional application No. 61/145,647, filed on Jan. 19, 2009.

(51) Int. Cl. G06F 17/30

(52) U.S. Cl. 707/748; 707/E17.014

(57) ABSTRACT

Tabular survey data may be automatically imported into a marketing database, including determining a multi-factor score for each column of data. The multi-factor score rates a relative likelihood that a given column represents survey question and/or survey response data, as opposed to respondent-identifying data.

### CROSS REFERENCE TO RELATED APPLICATIONS

This application is continuation in part of U.S. application Ser. No. 12/689,988, filed Jan. 19, 2010, titled “DATABASE MARKETING SYSTEM AND METHOD,” having Attorney Docket No. APPA-2009003, and naming the following inventors: Christopher Hahn, Kabir Shahani, and Derek Slager. U.S. application Ser. No. 12/689,988 claims the benefit of priority to U.S. Provisional Application No. 61/145,647, filed Jan. 19, 2009, titled “DATABASE MARKETING SYSTEM AND METHOD,” having Attorney Docket No. APPA-2008002, and naming the following inventors: Christopher Hahn, Kabir Shahani, and Derek Slager. The above-cited applications are incorporated herein by reference in their entireties, for all purposes.

### FIELD

The present disclosure relates to marketing, and more particularly to computer-managed health-care marketing.

### BACKGROUND

Marketers in the health care field (as well as other marketing fields) commonly use databases of customers or potential customers (also referred to as “leads”) to generate personalized communications to promote a product or service. The method of communication can be any addressable medium, e.g., direct mail, e-mail, telemarketing, and the like.

A marketing database may combine of disparate sources of customer, lead, and/or prospect information so that marketing professionals may act on that information. In some cases, a marketing database may be included in and/or managed using an enterprise marketing management software suite.

Commonly, trade shows, trade fairs, trade exhibitions, “expos,” or other like industry-related exhibitions (collectively referred to herein as “trade shows”) may be a source of customer, lead, and/or prospect information.

Trade show organizers commonly distribute one or more surveys to attendees of a trade show, recording survey responses and identifying information from the respondents. Such survey responses may indicate products and/or services that a respondent may be interested in.

During a trade show, exhibitors frequently employ a scanning device to track attendees who visit a given exhibition booth. For example, many attendees who visit a given exhibition booth may scan or swipe a card, badge, or other information-bearing device through a magnetic card scanner, a radio-frequency identification (“RFID”) scanner, or other like contact- or contactless scanning device. The scanning device may thus be used to track which trade show attendees have visited a given booth.

Periodically (e.g., at the end of each day of the trade show) and/or at the conclusion of the trade show, the organizers frequently provide booth exhibitors with information about which attendees visited the exhibitors' booths. This information commonly takes the form of a data file (e.g., a spreadsheet data file, delimited text file, or the like) including identifying information and survey responses associated with attendees who visited the exhibitor's booths.

However, even given such a data file, marketers associated with a trade show exhibitor may nonetheless lack automated tools for cleanly importing such customer, lead, and/or prospect information (including survey responses) into a marketing database.

### BRIEF DESCRIPTION OF THE DRAWINGS

FIG. 1 is a network diagram in accordance with one embodiment.

FIG. 2 illustrates one embodiment of a market-segmentation computer.

FIG. 3 illustrates a simplified set of exemplary survey data in accordance with one embodiment.

FIG. 4 illustrates a routine for processing and importing survey data into a marketing database, in accordance with one embodiment.

FIG. 5 illustrates a subroutine 500 for automatically identifying one or more question/response column pairs in tabular survey data, in accordance with one embodiment.

FIGS. 6A-D illustrate several exemplary match-factor subroutines that may be employed in accordance with one embodiment.

FIGS. 7A-C illustrate several exemplary bonus-factor subroutines that may be employed in accordance with one embodiment.

FIG. 8 illustrates a survey-import user interface, such as may be provided by marketing-survey processing computer 200 in accordance with one embodiment.

### DESCRIPTION

The detailed description that follows is represented largely in terms of processes and symbolic representations of operations by conventional computer components, including a processor, memory storage devices for the processor, connected display devices, and input devices. Furthermore, these processes and operations may utilize conventional computer components in a heterogeneous distributed computing environment, including remote file Servers, computer Servers, and memory storage devices. Each of these conventional distributed computing components is accessible by the processor via a communication network.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein.

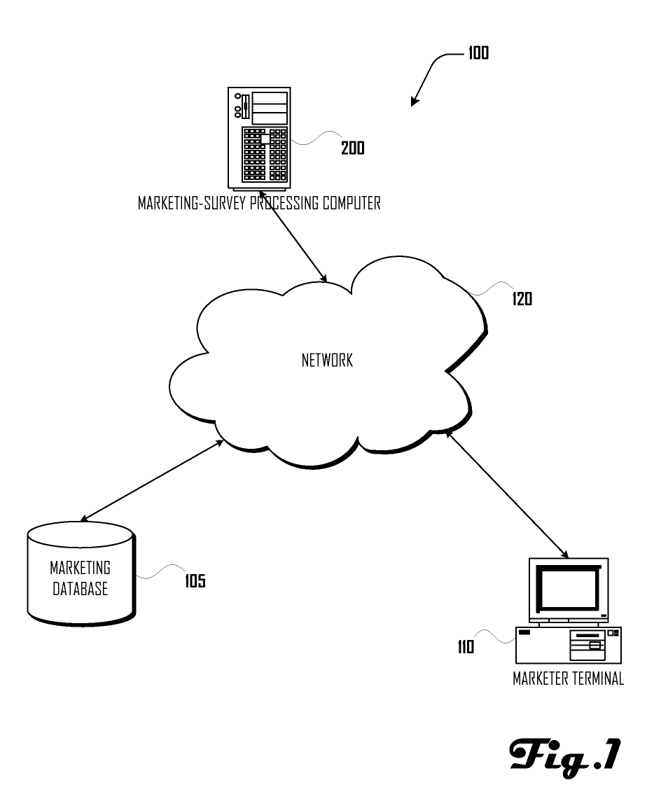

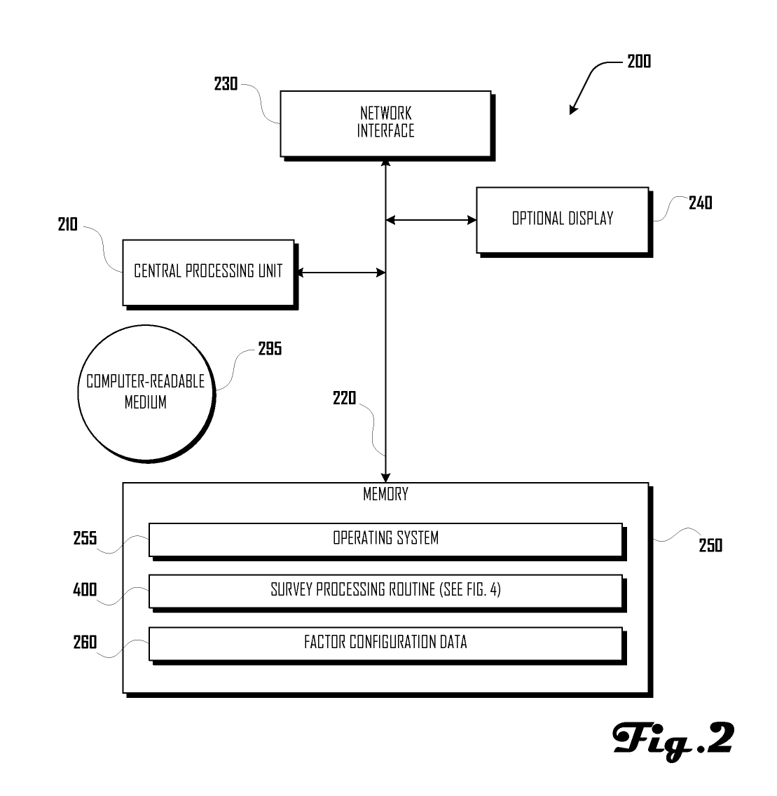

FIG. 1 illustrates a number of interconnected devices in accordance with one embodiment. Marketing database 105, marketer terminal 110, and marketing-survey processing computer 200 are connected to network 120. In various embodiments, network 120 comprises communication switching, routing, and/or data storage capabilities. In various embodiments, network 120 may comprise some or all of the Internet, one or more intranets, and wired and/or wireless network portions. In various embodiments, there may be more than one marketing database 105, and/or marketer terminal 110. Moreover, while FIG. 1 shows a single marketing-survey processing computer 200, in alternative embodiments, the functions, processes, and routines performed by marketing-survey processing computer 200 could be hosted or distributed among two or more different devices. Many embodiments may use multiple devices to comprise one logical device—for example, when marketing-survey processing computer 200 and/or marketing database 105 are executed or hosted in a “cloud computing” environment.

Alternatively, in some embodiments, two or more of marketing-survey processing computer 200, marketer terminal 110, and/or marketing database 105 may be hosted on a single physical computing device. For example, in some embodiments, marketing database 105 may be a process executing on marketing-survey processing computer 200.

Marketer terminal 110 may be any device that is capable of communicating with marketing-survey processing computer 200, including desktop computers, laptop computers, mobile phones and other mobile devices, PDAs, set-top boxes, and the like.

FIG. 2 illustrates an exemplary marketing-survey processing computer 200. The example system of FIG. 2 depicts a number of subsystems, modules, routines, and engines, some or all of which may by employed in a particular embodiment; the systems, modules, routines, and engines are not, however, limited to those illustrated. Other embodiments could be practiced in any number of logical software and physical hardware components and modules. The modules and components are listed herein merely for example.

Marketing-survey processing computer 200 includes a processing unit 210, a memory 225, and an optional display 240, all interconnected, along with network interface 230, via bus 220. Memory 250 generally comprises a random access memory (“RAM”), a read only memory (“ROM”), and/or a permanent mass storage device, such as a disk drive. In some embodiments, memory 250 may also comprise a local and/or remote database, database server, and/or database service (e.g., marketing database 105). In other embodiments, network interface 230 and/or other database interface (not shown) may be used to communicate with a database (e.g., marketing database 105). Memory 250 stores program code for some or all of a survey processing routine 400 and a factor configuration data 260. In addition, memory 250 also stores an operating system 255.

These and other software components may be loaded from a computer readable storage medium 295 into memory 250 of marketing-survey processing computer 200 using a drive mechanism (not shown) associated with a non-transient, tangible, computer readable storage medium 295, such as a floppy disc, tape, DVD/CD-ROM drive, memory card. In some embodiments, software components may also be loaded via the network interface 230 or other non-storage media.

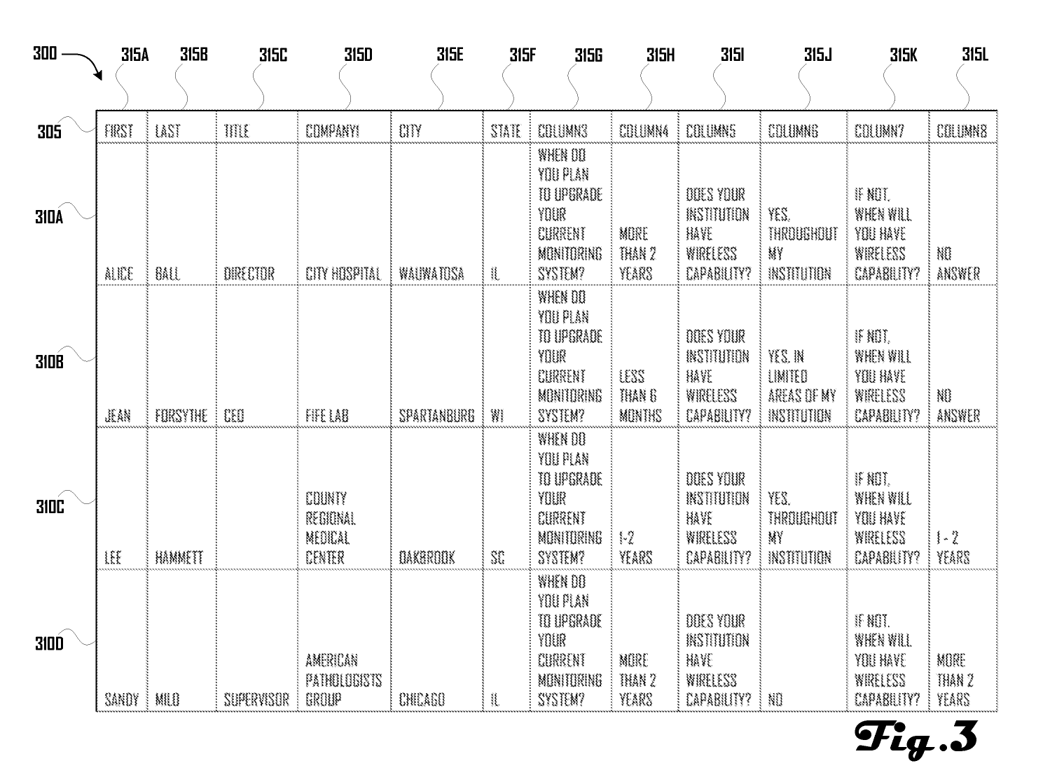

FIG. 3 illustrates a simplified set of exemplary survey data 300 that will be used to illustrate the various processes and systems described below. Survey data 300 is organized into a plurality of data rows 310A-D, which indicate individual survey respondents. For example, row 310A indicates a plurality of data cells corresponding to a respondent named Alice Ball.

Survey data 300 is further organized a plurality of data columns 315A-L, which indicate various fields of data that may be present in each of data rows 310A-D, fields that are “named” or identified by the cells making up header row 305. For example, column 315A indicates a plurality of data cells corresponding to a FIRST (name) field for each of rows 310A-D.

Put another way, survey data 300 is “tabular” data or data that is organized into two dimensions: one dimension indicating individual survey respondents, the other dimension indicating various fields of data that may be present for each individual survey respondent. As the term is used herein, a data “row” refers to the former dimension (indicating survey respondents), while a data “column” refers to the latter dimension (indicating fields of data).

As the term is used herein, a data “cell” or simply “cell” refers to the value (e.g., string, number, or the like) located at the intersection of a given row and a given column. Some cells may have an empty or null value (see, e.g., the empty cell at the intersection of row 310C and column 315C).

In the exemplary data, columns 315A-F indicate respondent-identifying and/or respondent-demographic fields, while columns 315G-L include several question/response column pairs. Specifically, response column 315H indicates responses to questions indicated by question column 315G, response column 315J indicates responses to questions indicated by question column 315I, and response column 315L indicates responses to questions indicated by question column 315K. In other embodiments, there may be more, fewer, and/or different columns, and column headers may differ from those illustrated. In some embodiments, some column header cells may be empty.

In various embodiments, survey data 300 may take the form of a spreadsheet data file, or other structured data, such as delimited text (e.g., a comma-separated values file, tab-delimited text file, or the like), data marked up in Extensible Markup Language (“XML”), an XML-based language, or the like. Additional features and typical characteristics of survey data 300 are discussed further below.

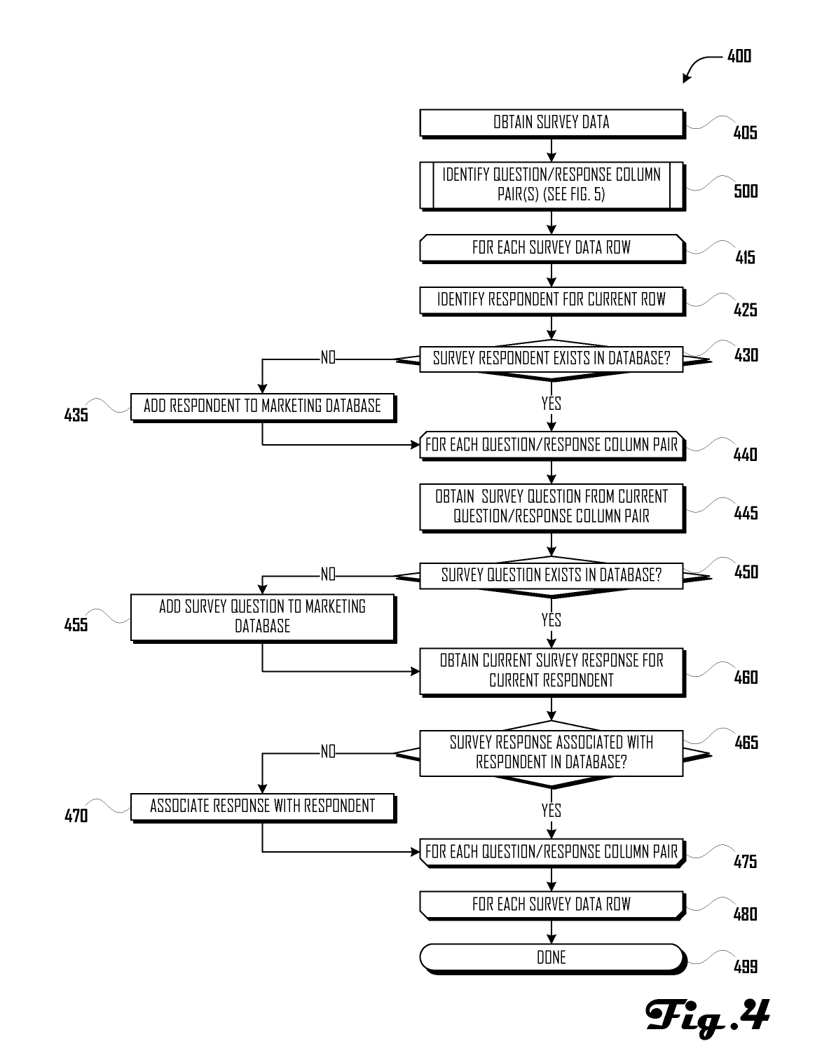

FIG. 4 illustrates a routine 400 for processing and importing survey data into a marketing database, such as may be performed by marketing-survey processing computer 200 in accordance with one embodiment. In some embodiments, the survey data may be subjected to further processing (not shown) before being imported into the marketing database. For example, in one embodiment, contact data for respondents identified in the survey data may be cleaned, normalized, and/or de-duplicated (not shown) during the import process. Additionally, as with all of the routines and subroutines described herein, the order of operations shown in FIG. 4 is merely illustrative, and in other embodiments, similar operations may be performed according to a different order of operations.

In block 405, routine 400 obtains tabular survey data (e.g., survey data 300). In some embodiments, the survey data may have been generated and/or assembled by a trade show organizer, as discussed above. In various embodiments, routine 400 may obtain the survey data from such a trade show organizer or via a marketer terminal (e.g., marketer terminal 110).

As discussed above, the survey data may have a header row including human-readable names for some or all of the data columns. However, even if a header row is present, the column names (header cell values) may not be consistent from one set of survey data to another. For example, different trade show organizers may use different column names to represent the same type of field. Consequently, the column names (header cell values) may not be sufficient for reliable, automatic machine-identification of particular columns in the survey data.

In addition, different sets of survey data may organize similar columns in different orders. For example, in many cases, the survey data may be generally organized into a contiguous block of several respondent-identifying and/or respondent-demographic columns and another contiguous block of several question/response column pairs. However, in some cases, a block of respondent-identifying columns may precede a block of question/response column pairs (as in survey data 300); whereas in other cases, a block of question/response column pairs may precede a block of respondent-identifying columns. Similarly, different sets of survey data may have different quantities of respondent-identifying columns and/or question/response column pairs. Consequently, generalizations about the columnar organization of the survey data may also be insufficient for reliable, automatic machine-identification of particular columns in the survey data.

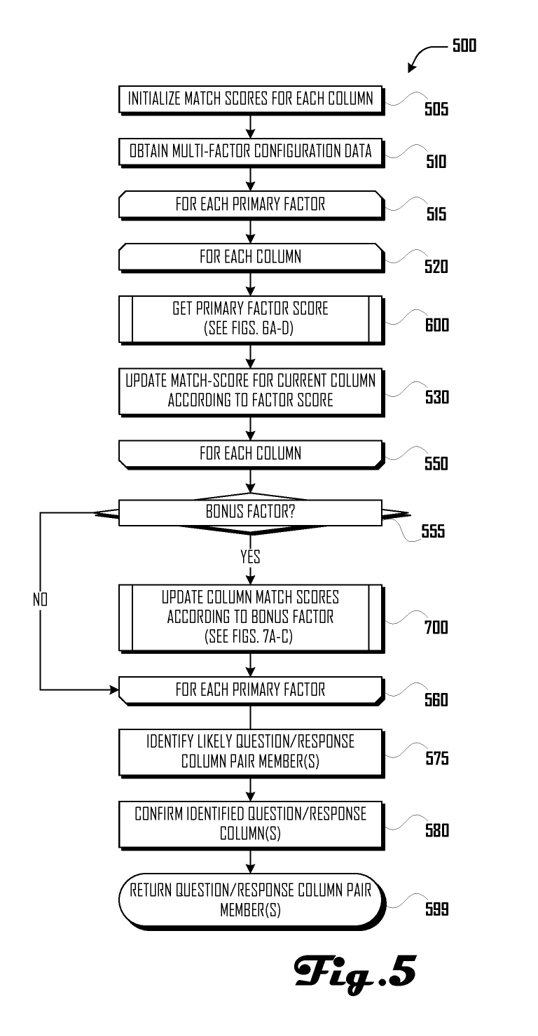

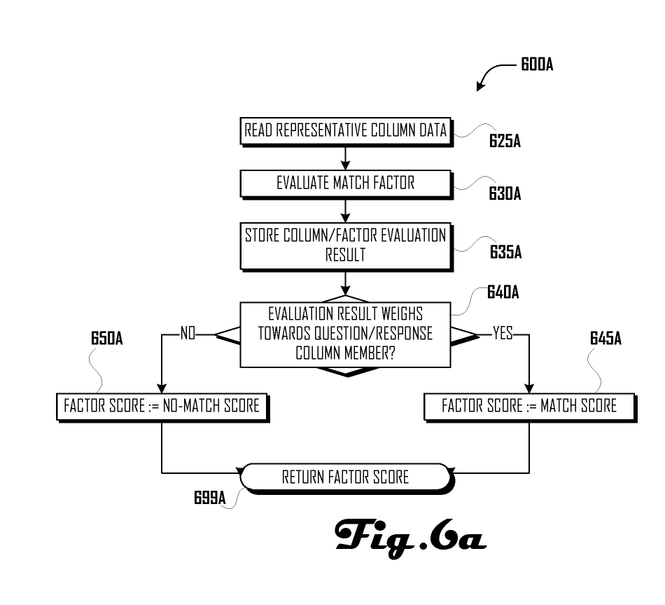

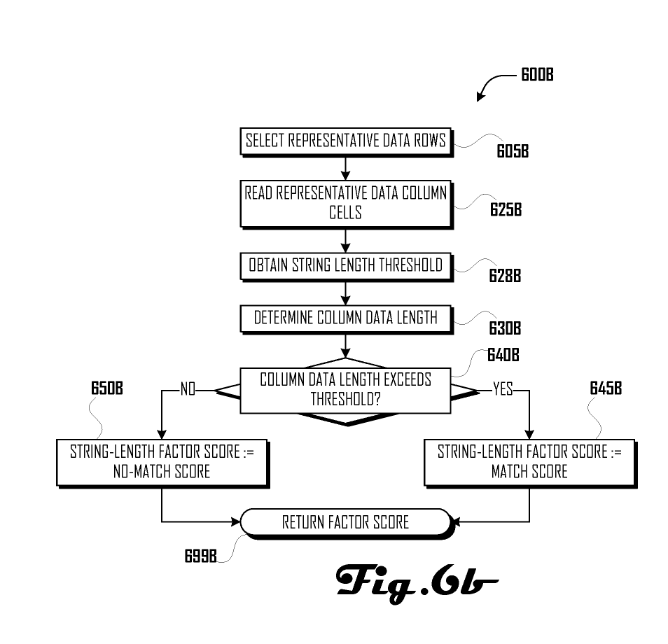

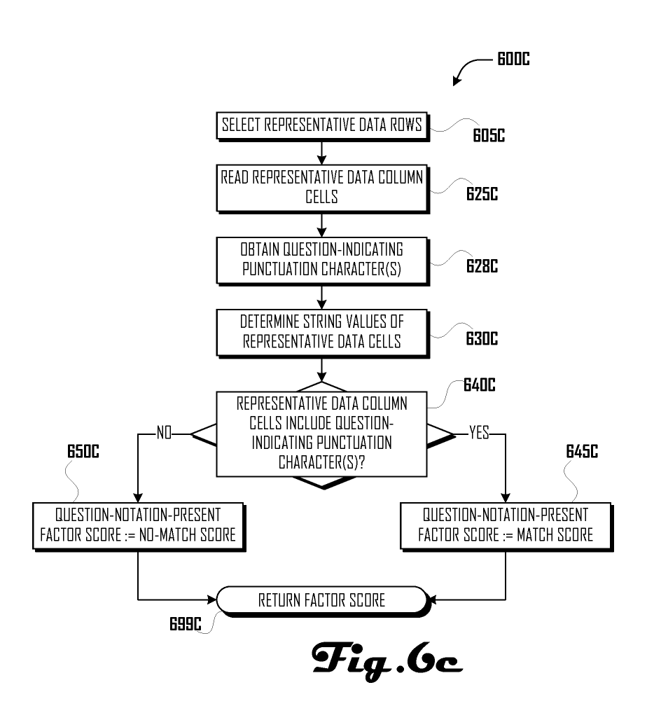

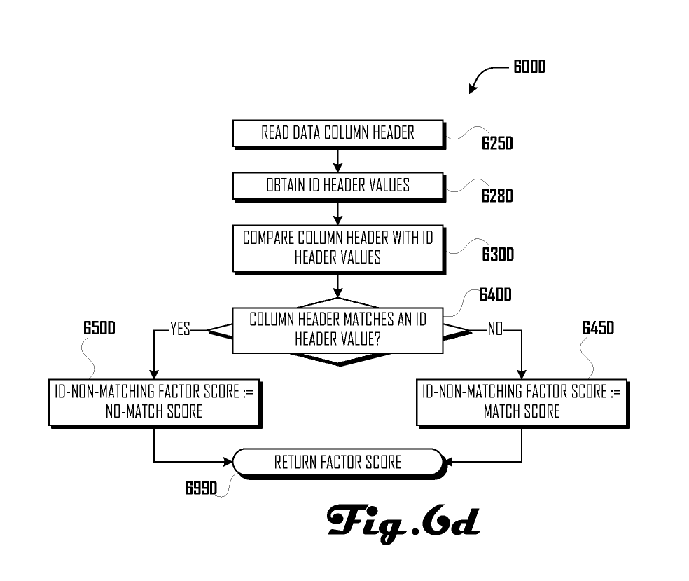

Nonetheless, in subroutine block 500, routine 400 automatically identifies one or more question/response column pairs in the survey data according to processes illustrated in FIG. 5, discussed below. In some embodiments, this automatic identification may include identifying a column in the survey data that indicates the first question among a block of question/response column pairs. In other embodiments, the automatic identification may include identifying a plurality of question columns and/or response columns in the survey data. Regardless, subroutine block 500 provides data from which the one or more question/response column pairs in the survey data can be identified.

Beginning in opening loop block 415, routine 400 processes each data row of the survey data. In block 425, routine 400 identifies a respondent corresponding to the current row. For example, when processing row 310A of survey data 300, routine 400 identify a respondent with first and last names “Alice” and “Ball,” with a title of “Director,” with a company of “City Hospital,” and so on. In some embodiments, column scores and/or other data generated during execution of subroutine 500 may be used in block 425 to determine columns identifying the respondent. In some embodiments, the identification process may also include cleaning, normalizing, and/or de-duplicating processes (not shown).

In decision block 430, routine 400 determines whether a record corresponding to the identified respondent exists in the marketing database (e.g., database 105). If not, then in block 435, routine 400 adds to the marketing database a record corresponding to the identified respondent.

Beginning in opening loop block 440, routine 400 processes each question/response column pair identified according to the data provided in subroutine block 500.

In block 445, routine 400 obtains the survey question from the current question/response column pair. In other words, routine 400 obtains the value of the survey question cell corresponding to the current respondent and the current question/response column pair. For example, when processing row 310A of survey data 300 and question/response column pair 315G-H, routine 400 may obtain a question cell value of “When do you plan to upgrade your current monitoring system?”

In decision block 450, routine 400 determines whether a record corresponding to the current survey question exists in the marketing database. If not, then in block 455, routine 400 adds to the marketing database a record corresponding to the current survey question.

In block 460, routine 400 obtains the survey response from the current question/response column pair. In other words, routine 400 obtains the value of the survey response cell corresponding to the current respondent and the current question/response column pair. For example, when processing row 310A of survey data 300 and question/response column pair 315G-H, routine 400 may obtain a response cell value of “More than 2 years.”

In decision block 465, routine 400 determines whether a record corresponding to the current survey response is associated in the marketing database with the current respondent. If not, then in block 455, routine 400 associates a record corresponding to the current survey response with a record corresponding to the current respondent in the marketing database.

In ending loop block 475, routine 400 iterates back to block 440 to process the next question/response column pair (if any). In ending loop block 480, routine 400 iterates back to block 415 to process the next survey data row (if any). Having processed all data rows, routine 400 ends in block 499.

FIG. 5 illustrates a subroutine 500 for automatically identifying one or more question/response column pairs in survey data organized into rows and columns of data cells, in accordance with one embodiment.

In block 505, subroutine 500 initializes at least one match score for each data column in the survey data. In some embodiments, such match scores may be stored (at least transiently) in an array or similar data structure. In one embodiment, the match scores may be initialized to zero and incremented according to how likely it is that a given column is part of a question/response column pair, as discussed further below. Other embodiments may use other scoring schemes.

In block 510, subroutine 500 obtains configuration data for a plurality of match factors. For example, in some embodiments, subroutine 500 may obtain data that defines one or more thresholds and/or scores corresponding to a number of match factor tests. In one embodiment, subroutine 500 may obtain configuration data that includes data such as the following.

<string id=“SurveyQuestion.MatchFactors”>

<list>

<string>ColumnLength:40:1.0</string>
<string>QuestionNotationPresent:1:1.0</string>
<string>ColumnHeaderNoMatchFieldId:0:2.0</string>
<string>ContiguousNonMatchIdBlock:0:2.0</string>

</list>

</string>
<string id=“SurveyQuestion.MatchBonusGroups”>

<list>
<string>QuestionNotationFollowedByNonQuestion:0:2.0</string>
</list>

</string>
<string id=“SurveyQuestion.MatchBonusGroups”>

<list>

<string>MatchThreshold:5.0</string>

</list>

</string>

In some embodiments, some match factors may be determinable using only data associated with any one column. For example, one match factor may test whether cell values in a given column end with (or otherwise include) a question-notation character (e.g., a question mark). If so, then the given column may be assigned a question-notation factor match score (e.g., 1.0); if not the given column may be assigned a question-notation factor no-match score (e.g., 0.0). Such a question-notation match factor can be determined for a column without regard to data and/or match scores associated with other columns. Therefore, such a question-notation match factor would be considered a “primary” match factor.

Other match factors may be determinable by comparing or analyzing groups of primary match factor scores. For example, one match factor may test whether a given column has a question-notation match score and is adjacent to a column having a question-notation no-match score. Such a question-preceding-non-question factor may thus require match factor scores associated with more than a single column and would therefore be considered a “multi-column” match factor. Such factors that provide an additional match score based on a particular grouping or arrangement of primary scores may also be referred to as “bonus” factors.

Beginning in opening loop block 515, subroutine 500 processes each of the primary match factors. Beginning in opening loop block 520, subroutine 500 processes each column of the survey data according to the current primary match factor.

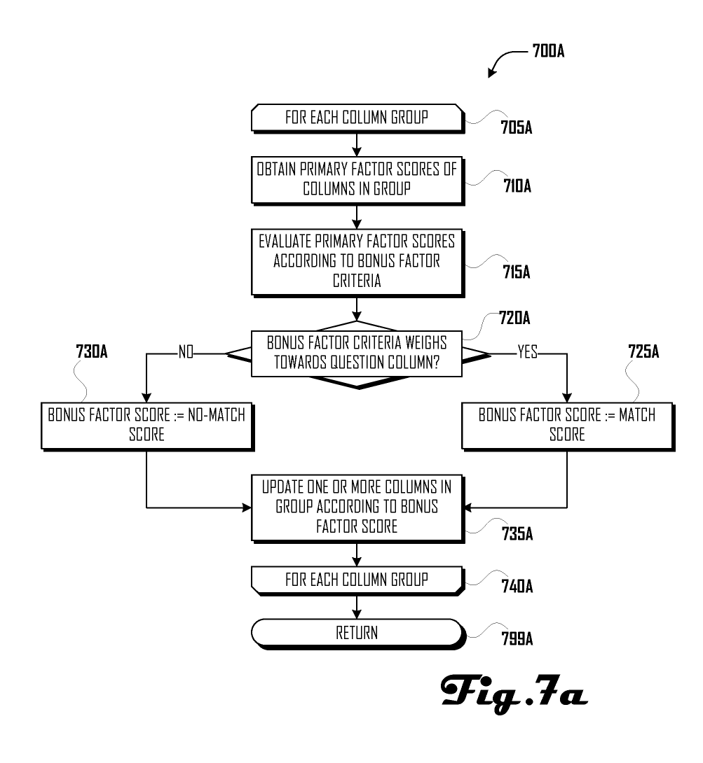

In subroutine block 600, subroutine 500 evaluates the current column to obtain a factor score according to the current primary match factor. FIGS. 6A-D illustrate several exemplary match-factor subroutines that may be employed in accordance with one embodiment.

Having obtained a factor score for the current column and the current primary match factor, in block 530, subroutine 500 updates the match-score (initialized in block 505) for the current column. For example, in one embodiment, for a given column, subroutine 500 may obtain in subroutine block 600 a question-notation factor score of, for example, 1.0, which factor score is added to the current column's match score in block 530. In closing loop block 550, subroutine 500 iterates back to block 520 to process the next column of the survey data (if any).

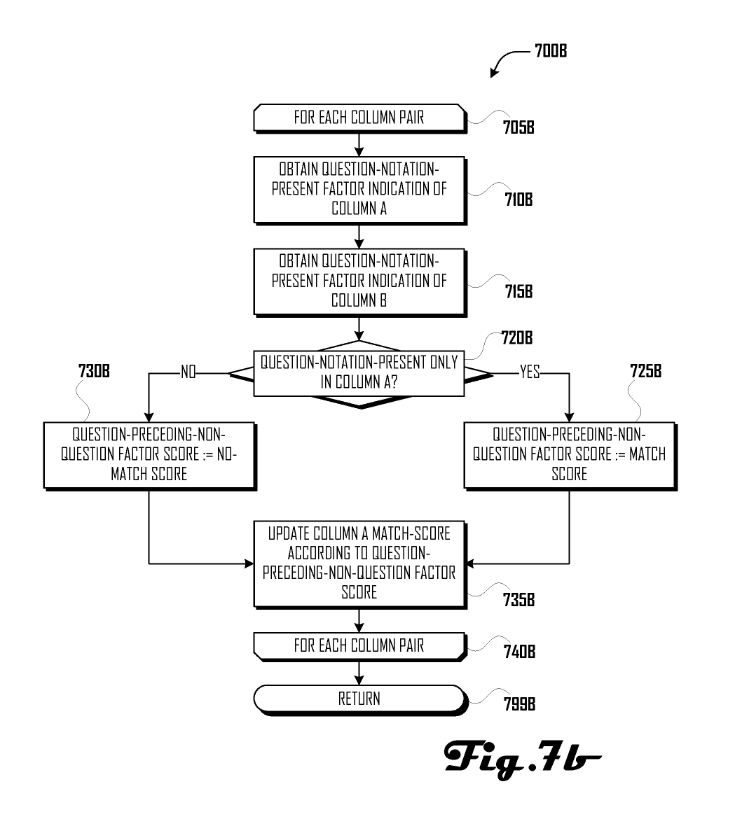

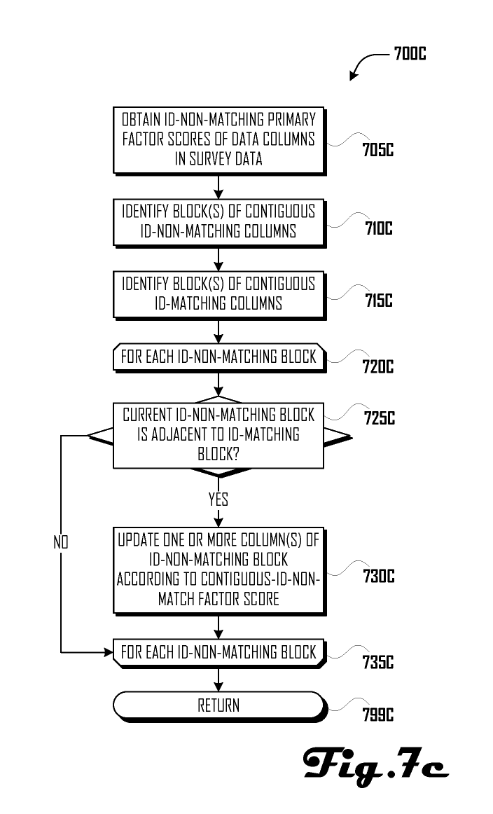

Having processed each data column according to the current primary match factor, in decision block 555, subroutine 500 determines whether there is a “bonus” factor that is based on a particular grouping or arrangement of columns according to the current primary match factor. If so, then in subroutine block 700, subroutine 500 updates one or more column match scores according to the bonus factor. FIGS. 7A-C illustrate several exemplary bonus-factor subroutines that may be employed in some embodiments.

In closing loop block 560, subroutine 500 iterates back to block 515 to process the next primary match factor (if any). Once all match factors have been processed, each column is associated with a column match score according to a combination of individual factor scores.

Using such column match scores, in block 575, subroutine 500 identifies one or more likely question and/or response columns according to the column match scores. For example, in one embodiment, the “left”-most column having the highest column match score may be identified as the likely first column of a block of question/response column pairs.

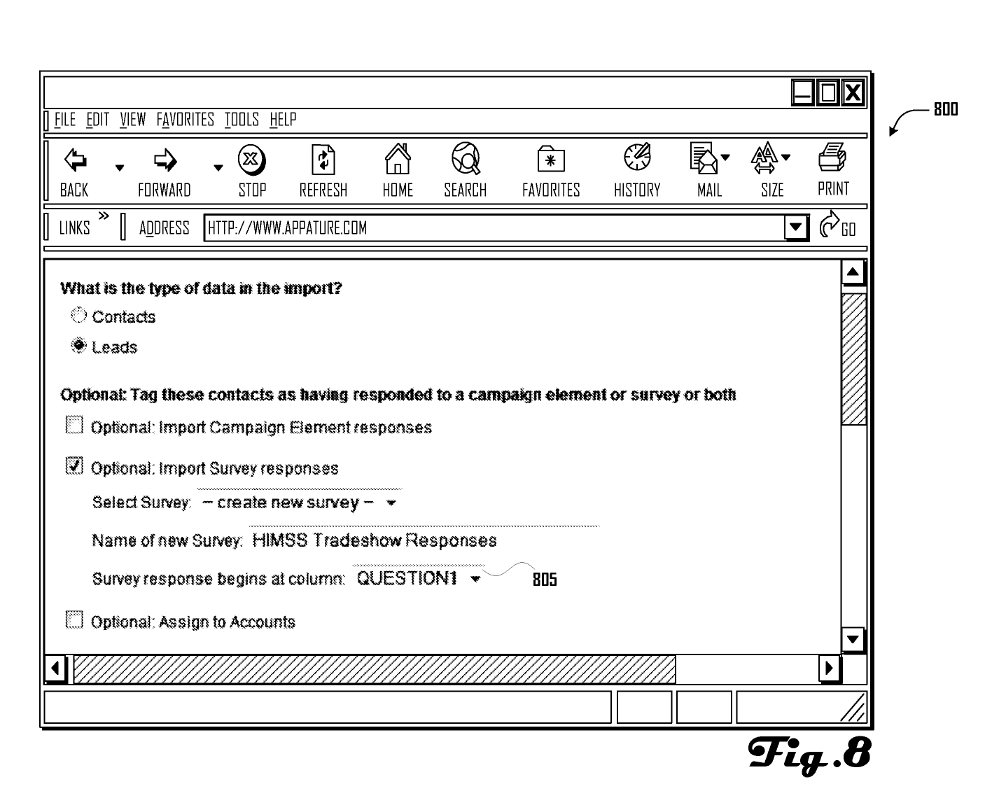

In some embodiments, in block 580, subroutine 500 confirms the accuracy of the likely column(s) identified in block 575. For example, in one embodiment, subroutine 500 may present a user interface indicating the column(s) that have been identified as likely members of a block of one or more question/response column pairs and allowing a user to confirm or correct the automatically identified column(s). (See, e.g., FIG. 8, discussed below.)

Subroutine 500 ends in block 599, returning one or more columns that have been identified as being members of one or more question/response column pairs.

FIG. 6A illustrates a “generic” match-factor subroutine 600A that may be employed to obtain a factor score for a given match factor as applied to a given column in accordance with one embodiment. The general principles illustrated in subroutine 600A may be variously adapted to suit various specific match factor subroutines, such as those illustrated in FIGS. 6B-D, discussed below.

In block 625A, subroutine 600A reads one or more representative cells of data for the given column. For example, in one embodiment, the match factor being processed may use a header value for the given column, in which case a header cell (the cell in the header row for the given column) may be read in block 625A. In another embodiment, the match factor being processed may use one or more data values for the given column, in which case one or more data cells (cells in one or more data rows for the given column) may be read in block 625A.

In block 630A, subroutine 600A evaluates the given match factor using the one or more representative cells of data read in block 625A. Several specific exemplary match-factor-evaluation processes are shown in FIGS. 6B-D, discussed below.

In some embodiments, the match factor evaluation of block 630A may result in an indication that the representative cell data is either a match (more likely to be a member of a question/response column pair) or a no-match (not more likely to be a member of a question/response column pair) according to the given match factor. In some embodiments, this match/no-match determination may be stored (at least transiently) for subsequent use by another factor-evaluation subroutine (e.g., “bonus” factor subroutines 700A-C, discussed below).

In decision block 640A, subroutine 600A determines whether the match-factor evaluation result obtained in block 630A indicates that the given column is more likely to be a member of a question/response column pair (e.g., whether the representative cell data is a match or a no-match). If the evaluation result indicates that the given column is a “match,” then in block 645A, a “match” score is determined and assigned to a factor score. Conversely, if the evaluation result indicates that the given column is not “match,” then in block 650A, a “no-match” score is determined and assigned to the factor score.

Subroutine 600A ends in block 699A, returning the factor score assigned in block 645A or 650A.

FIG. 6B illustrates a string-length match-factor subroutine 600B that may be employed to obtain a factor score for a string-length match factor as applied to a given column in accordance with one embodiment. In one embodiment, string-length match-factor subroutine 600B assesses string lengths of one or more data cells of the given column, giving a match score to columns whose data cells are longer than a given threshold value, as survey question columns have been observed to frequently include relatively long string values compared to other types of columns.

In block 625B, subroutine 600B reads one or more representative cells of data for the given column. For example, in one embodiment, the string-length match factor may use one or more data values for the given column (which may be indicated in cases where question strings typically appear in column data cells), in which case one or more data cells (cells in one or more data rows for the given column) may be read in block 625B. In other embodiments, the string-length match factor may use a header value for the given column (which may be indicated in cases where question strings typically appear in column headers), in which case one or more data cells (cells in one or more data rows for the given column) may be read in block 625B.

In block 628B, subroutine 600B obtains a string-length threshold (e.g., from factor configuration data, as discussed above in regard to block 510). For example, in one embodiment, a string-length threshold of 40 may be obtained. In other embodiments, higher and/or lower thresholds may be employed. For example, in one embodiment, one string-length match-factor may apply a match score for string lengths above, e.g., 30; whereas a second string-length match-factor may apply a second match score for string lengths above a higher threshold, e.g., 60.

In block 630B, subroutine 600B determines string-length values for the representative data (or header) cell or cells.

In decision block 640B, subroutine 600B determines whether the representative cell(s) read in block 625B exhibit string-lengths greater than the threshold (or, in some cases, greater then or equal to the threshold).

If two or more representative cell values are to be considered, then various embodiments may take various approaches to evaluating the two or more cell values. For example, in one embodiment, an average or other statistical measure of the cell string lengths may be determined and compared with the threshold. In other embodiments, each cell value may be compared individually, a further determination being made as to whether at least some number of the individual cell values (e.g., a majority of cell values, every cell value, or the like) exhibit string-lengths greater than the threshold.

If in decision block 640B, subroutine 600B determines that the representative cell(s) exhibit string-lengths greater than (or greater then or equal to) the threshold), then in block 645B, a “match” score (e.g., “1.0”) is determined and assigned to a string-length factor score. Otherwise, in block 650B, a “no-match” score (e.g., “0.0”) is determined and assigned to the-length factor score.

Subroutine 600B ends in block 699B, returning the factor score assigned in block 645B or 650B.

FIG. 6C illustrates a question-notation-present match-factor subroutine 600C that may be employed to obtain a factor score for a question-notation-present match factor as applied to a given column in accordance with one embodiment. In one embodiment, question-notation-present match-factor subroutine 600C assesses whether one or more data cells of the given column include one or more question-notation characters (e.g., “?”, “ [symbol] ”, or the like) in a particular string position (e.g., at the end of the string for a “?” character, at the beginning of the string for a “ [symbol] ” character, or the like).

In block 625C, subroutine 600C reads one or more representative cells of data for the given column. For example, in one embodiment, the question-notation-present match factor may use one or more data values for the given column, in which case one or more data cells (cells in one or more data rows for the given column) may be read in block 625C.

In block 628C, subroutine 600C obtains one or more question-notation-present characters. In block 630C, subroutine 600C determines string values for the one or more representative data cells. In some embodiments, determining such string values may include a normalization and/or data “cleaning” process, such as stripping whitespace from the beginnings and/or ends of the strings.

In decision block 640C, subroutine 600C determines whether the representative cell(s) read in block 625C include some or all of the one or more question-notation-present characters in particular string positions (e.g., at the end or beginning of the string).

If two or more representative cell values are to be considered, then various embodiments may take various approaches to evaluating the two or more cell values. For example, in one embodiment, each cell value may be compared individually, a further determination being made as to whether at least some number of the individual cell values (e.g., a majority of cell values, every cell value, or the like) include some or all of the one or more question-notation-present characters in particular string positions.

If in decision block 640C, subroutine 600C determines that the representative cell(s) include at appropriate string positions some or all of the one or more question-notation-present characters, then in block 645C, a “match” score (e.g., “1.0”) is determined and assigned to a question-notation-present factor score. Otherwise, in block 650C, a “no-match” score (e.g., “0.0”) is determined and assigned to the question-notation-present factor score.

Subroutine 600C ends in block 699C, returning the factor score assigned in block 645C or 650C.

FIG. 6D illustrates an id-non-matching match-factor subroutine 600D that may be employed to obtain a factor score for an id-non-matching match factor as applied to a given column in accordance with one embodiment. In one embodiment, id-non-matching match-factor subroutine 600D whether the header or name of the given column does not match one or more headers or names that are commonly used to indicate columns of contact-identifying and/or demographic data.

In block 625D, subroutine 600D reads a header cell for the given column.

In block 628D, subroutine 600D obtains one or more “ID” header values that that are commonly used to indicate columns of contact-identifying and/or demographic data. For example, in one embodiment, subroutine 600D may obtain a list of one or more header values such as some or all of the following: “first”, “last”, “name”, “first name”, “last name”, “title”, “company”, “address”, “city”, “state”, “zip”, “country”, “phone”, “fax”, “email”, “note”, or the like.

In block 630D, subroutine 600D compares the column header of the given column with the one or more ID header values. In some embodiments, this comparison may include determining an edit distance (e.g., a Levenshtein distance or the like) between the column header and some of all of the ID header values. In some embodiments, data collected incident to this comparison may also be used to map (not shown) ID-header-matching columns to contact- and/or lead-identifying fields in the marketing database, which mapping may be utilized when matching survey respondents to existing records in the marketing database.

In decision block 640D, subroutine 600D determines whether the column header of the given column matches at least one of the ID header values. In some embodiments, this determination may include determining whether an edit distance determined in block 630D meets or exceeds an edit-distance threshold configured for the id-non-matching match factor.

If in decision block 640D, subroutine 600D determines that the column header of the given column fails to match at least one of the ID header values, then in block 645D, a “match” score (e.g., “2.0”) is determined (as failing to match an ID header is suggestive of a question and/or response column) and assigned to a id-non-matching factor score. Otherwise, in block 650D, a “no-match” score (e.g., “0.0”) is determined and assigned to the id-non-matching factor score.

Subroutine 600D ends in block 699D, returning the factor score assigned in block 645D or 650D.

FIG. 7A illustrates a “generic” “bonus” match-factor subroutine 700A that may be employed to obtain a factor score for a given bonus match factor based on a given primary match score in accordance with one embodiment. The general principles illustrated in subroutine 700A may be variously adapted to suit various specific bonus match factor subroutines, such as those illustrated in FIGS. 7B-C, discussed below.

Beginning in opening loop block 705A, subroutine 700A processes one or more groups of columns from the survey data. The number and configuration of column groups is match-factor dependent. For some bonus match factors, there may be one column group for each pair of adjacent columns. For other bonus match factors, there may be one column group including all data columns in the survey data. Still other bonus match factors may use different column groupings.

In block 710A, subroutine 700A reads a group of primary factor scores associated respectively with the current column group.

In block 715A, subroutine 700A evaluates the group of primary factor scores according to a match-factor-evaluation process. Several specific exemplary match-factor-evaluation processes are shown in FIGS. 7B-C, discussed below.

In some embodiments, the match factor evaluation of block 715A may result in an indication that one or more of the columns of the current column group is either a “match” (more likely to be a member of a question/response column pair) or a “no-match” (not more likely to be a member of a question/response column pair) according to the given bonus match factor.

In decision block 720A, subroutine 700A determines whether the match-factor evaluation result obtained in block 715A indicates that one or more of the columns of the current column group is more likely to be a member of a question/response column pair. If the evaluation result indicates that the given column is a “match,” then in block 725A, a “match” score is determined and assigned to a bonus factor score. Conversely, if the evaluation result indicates that the given column is not “match,” then in block 730A, a “no-match” score is determined and assigned to the bonus factor score.

In block 735A, subroutine 700A updates one or more of the columns of the current column group according to the bonus factor score assigned in block 725A or block 730A.

Subroutine 700A ends in block 799A.

FIG. 7B illustrates a question-preceding-non-question “bonus” match-factor subroutine 700B that may be employed to obtain a factor score for a question-preceding-non-question bonus match factor based on a question-notation-present primary match score in accordance with one embodiment.

Beginning in opening loop block 705B, subroutine 700B processes each column pair in the survey data. For example, in one iteration, subroutine 700B may process data columns 1 and 2; on a second iteration, data columns 2 and 3; and so on.

In block 710B, subroutine 700B obtains a question-notation-present primary factor score (or other question-notation-present indication) associated with the first column (“column A”) of the current column pair. In block 715B, subroutine 700B obtains a question-notation-present primary factor score (or other question-notation-present indication) associated the other column (“column B”) of the current column pair.

In decision block 720B, subroutine 700B evaluates the data obtained in blocks 710B and 715B to determine whether a non-question-notation-present column adjacently follows a question-notation-present column. If so, then in block 725B, a “match” score (e.g., “2.0”) is determined and assigned to a question-preceding-non-question factor score, as survey data often includes adjacent question and response column pairs. Otherwise, in block 730B, a “no-match” score (e.g., “0.0”) is determined and assigned to the question-preceding-non-question factor score.

In block 735B, subroutine 700B updates the column match score for column A of the current column group according to the question-preceding-non-question factor score assigned in block 725B or block 730B.

In closing loop block 740B, subroutine 700B iterates back to block 705B to process the column pair (if any) in the survey data. Subroutine 700B ends in block 799B.

FIG. 7C illustrates a contiguous-id-non-match “bonus” match-factor subroutine 700C that may be employed to obtain a factor score for a contiguous-id-non-match bonus match factor based on an id-non-matching primary match score in accordance with one embodiment. Subroutine 700C operates on a single group including all data columns of the survey data. It has been observed that question/response columns frequently occur in survey data in a block of contiguous columns adjacent (preceding or following) a block of contiguous contact-identification columns (whose headers match one or more known ID-header values, as discussed above in relation to FIG. 7D). Subroutine 700C is designed to assign “bonus” factor scores to non-ID-matching blocks of contiguous columns that are adjacent to ID-matching blocks of contiguous columns.

In block 705C, subroutine 700C obtains a group of id-non-matching primary factor scores (or other indications) corresponding respectively to the group of columns in the survey data.

Using the group of id-non-matching primary factor scores, in block 710C, subroutine 700C identifies at least one block of contiguous columns having headers that do not match “ID” header values (“ID-non-matching column block”); and in block 715C, subroutine 700C identifies at least one block of contiguous columns having headers that do match “ID” header values (“ID-matching column block”). In one embodiment, each of the ID-non-matching and ID-matching blocks includes at least a configurable threshold quantity of columns (e.g., at least five columns).

For example, in one embodiment, when processing survey data 300, subroutine 700C may in block 710C identify a block of columns 315G-L, and in block 715C, subroutine 700C may identify a block of columns 315A-F. In this embodiment, the former block of non-ID columns (columns 315G-L) is adjacent to the latter block of ID-matching columns (columns 315A-F).

Beginning in opening loop block 720C, subroutine 700C processes each ID-non-matching block. identified in block 710C.

In decision block 725C, subroutine 700C determines whether the current ID-non-matching block is adjacent to an ID-matching block in the survey data. If so, then in block 730C, subroutine 700C updates one or more of the columns making up the current ID-non-matching block according to a contiguous-id-non-match factor score (e.g., “5.0”). For example, in one embodiment, the first column of the ID-non-matching block may be so updated. In other embodiments, each column of the ID-non-matching block may be so updated.

In closing loop block 735C, subroutine 700C iterates back to block 720C to process the next ID-non-matching block (if any). Subroutine 700C ends in block 799C.

FIG. 8 illustrates a survey-import user interface 800, such as may be provided by marketing-survey processing computer 200 in accordance with one embodiment. User interface 800 includes a control 805 that indicates an automatically identified member of a question/response column pair, and by which a user can make a correction to the automatically identified member, if necessary.

Although specific embodiments have been illustrated and described herein, a whole variety of alternate and/or equivalent implementations may be substituted for the specific embodiments shown and described without departing from the scope of the present disclosure. For example, in alternate embodiments, match factors other than the exemplary match factors may be employed. For example, in one alternate embodiment, a match factor may be based on whether a column header value matches a list of header values that typically indicate survey question and/or response columns (e.g., “question”, “Q”, “answer”, “response”, or the like). This application is intended to cover any adaptations or variations of the embodiments discussed herein.

We claim:

1. A computer-implemented method for importing survey data into a health care marketing database, the method comprising:
obtaining, by the computer, the survey data including a plurality of data cells organized in a plurality of data rows and a plurality of data columns, said plurality of data rows corresponding respectively to a plurality of survey respondents, said plurality of data columns comprising a plurality of respondent-identification data columns and at least one question-and-response column pair, each question-and-response column pair including a survey question column and a survey response column;
determining, by the computer, a plurality of multi-factor match scores corresponding respectively to said plurality of data columns, wherein each multi-factor match score rates, according to a plurality of match factors, a relative likelihood that the corresponding data column is included in said at least one question-and-response column pair;
automatically identifying, by the computer according to said plurality of multi-factor match scores, said at least one question-and-response column pair among said plurality of data columns;
automatically updating, by the computer, the health care marketing database to include a plurality of survey-respondent contact records corresponding respectively to said plurality of survey respondents;
automatically updating, by the computer, the health care marketing database to include at least one survey-question record corresponding respectively to the at least one survey question column of said identified at least one question-and-response column pair; and
for each of said plurality of data rows, the computer automatically updating the health care marketing database to include at least one survey-response record associated with the survey respondent corresponding to the current data row, said at least one survey-response record corresponding respectively to the at least one survey response column of said identified at least one question-and-response column pair.

2. The method of claim 1, wherein determining said plurality of multi-factor match scores comprises:
selecting at least one analysis row from said plurality of data rows; and
for each of said plurality of data columns, analyzing at least one cell value corresponding to the current data column and said at least one analysis row.

3. The method of claim 2, wherein said plurality of match factors includes a question-notation-present factor, according to which analyzing said at least one cell value comprises:
obtaining a question-indicating punctuation character; and
determining whether said at least one cell value includes said question-indicating punctuation character.

4. The method of claim 3, wherein determining said plurality of multi-factor match scores further comprises, for each of said plurality of data columns:
when said at least one cell value includes said question-indicating punctuation character, determining a question-notation-present factor value to increase said relative likelihood that the corresponding data column is included in said at least one question-and-response column pair.

5. The method of claim 3, wherein said plurality of match factors further includes a question-preceding-non-question factor, according to which analyzing said at least one cell value further comprises:
when said at least one cell value includes said question-indicating punctuation character, determining whether an adjacent cell value does not include said question-indicating punctuation character.

6. The method of claim 5, wherein determining said plurality of multi-factor match scores further comprises, for each of said plurality of data columns:
when said adjacent cell value does not include said question-indicating punctuation character, determining a question-preceding-non-question factor to further increase said relative likelihood that the corresponding data column is included in said at least one question-and-response column pair.

7. The method of claim 2, wherein said plurality of match factors includes a string-length factor, and wherein analyzing said at least one cell value corresponding to the current data column and said at least one analysis row comprises:
obtaining a question-indicating string-length value; and
comparing said question-indicating string-length value with a string length of said at least one cell value.

8. The method of claim 7, wherein determining said plurality of multi-factor match scores further comprises, for each of said plurality of data columns:
when said string length of said at least one cell value exceeds said question-indicating string-length value, determining a string-length factor value to increase said relative likelihood that the corresponding data column is included in said at least one question-and-response column pair.

9. The method of claim 1, wherein said plurality of data cells comprise a header row including a plurality of header cells corresponding respectively to said plurality of data columns, and wherein determining said plurality of multi-factor match scores comprises, for each of said plurality of data columns, analyzing a header cell value corresponding to the current data column.

10. The method of claim 9, wherein said plurality of match factors includes an id-non-match factor, according to which analyzing said header cell value comprises:
obtaining a plurality of ID header values that typically correspond to column headers of said respondent-identification data columns; and
determining whether said header cell value does not match any of said plurality of ID header values.

11. The method of claim 10, wherein determining said plurality of multi-factor match scores further comprises, for each of said plurality of data columns:
when said header cell value does not match any of said plurality of ID header values, determining an id-non-match factor value to increase said relative likelihood that the corresponding data column is included in said at least one question-and-response column pair.

12. The method of claim 10, wherein said at least one question-and-response column pair comprises a plurality of question-and-response column pairs, and wherein said plurality of match factors includes a contiguous-id-non-match factor, according to which determining said plurality of multi-factor match scores further comprises:
determining a count of contiguous columns whose header cell values do not match any of said plurality of ID header values; and
comparing said count with a threshold value.

13. The method of claim 12, wherein determining said plurality of multi-factor match scores further comprises, for each of said plurality of data columns:
when said count exceeds said threshold value, determining a contiguous-id-non-match factor value to increase said relative likelihood that the corresponding data column is included in said at least one question-and-response column pair.

14. The method of claim 10, wherein said plurality of match factors includes a contiguous-id-match factor, according to which determining said plurality of multi-factor match scores further comprises:
determining a count of contiguous columns whose header cell values match at least one of said plurality of ID header values; and
comparing said count with a threshold value.

15. The method of claim 1, further comprising, before automatically updating the health care marketing database, obtaining a manual confirmation that said at least one question-and-response column pair was correctly automatically identified among said plurality of data columns.

16. The method of claim 1, further comprising, obtaining configuration data defining said plurality of match factors.

17. A computing apparatus comprising a processor and a memory storing instructions that, when executed by the processor, perform the method of claim 1.

18. A tangible computer-readable medium non-transiently storing instructions that, when executed by a processor, perform the method of claim 1.
